(19) United States
(12) Patent Application Publication
(10) Pub. No.: US 2025/0011207 A1
(43) Pub. Date: Jan. 9, 2025

(54) Methods of treating water

(71) Applicant: B.G. NEGEV TECHNOLOGIES AND APPLICATION LTD., AT BEN-GURION UNIVERSITY, Be'er Sheva (IL)

(72) Inventors: Jack Gilron, Be'er Sheva (IL); Yoram Oren, Be'er Sheva (IL); Zeev Ronen, Sde Boker (IL); Akshaya Verma, Sde Boker (IL)

(21) Appl. No.: 18/713,400

(22) PCT Filed: Nov. 24, 2022
(86) PCT No.: PCT/IL2022/051254

§ 371 Date: May 24, 2024

Related U.S. Application Data
(60) Provisional application No. 63/282,729, filed on Nov. 24, 2021.

(51) Int. Cl. C02F 3/28; B01D 61/24; B01D 61/28; B01D 63/10; B01D 69/02; C02F 101/10; C02F 101/12; C02F 101/16

(52) U.S. Cl. CPC C02F 3/2853; B01D 61/243; B01D 61/28; B01D 63/107; B01D 69/02; B01D 2325/42; C02F 2101/103; C02F 2101/106; C02F 2101/12; C02F 2101/163; C02F 2101/166; C02F 2209/01; C02F 2209/02; C02F 2209/03; C02F 2209/04; C02F 2209/06; C02F 2209/40; C02F 2301/046

(57) ABSTRACT

Provided herein are methods and systems for water purification from oxyanions, nitrate in particular, by Donnan dialysis unit coupled with a bioreactor, to allow the uninterrupted or minimally interrupted operation of the technological assembly.

### TECHNICAL FIELD

The invention pertains to methods of water purification, and to water treatment systems, particularly to ion-exchange membrane contactors and bioreactors, particularly when the water is contaminated with oxyanions, such as nitrate, nitrite, perchlorate, chromate, arsenite, arsenate, bromate, selenate, or chlorate.

### BACKGROUND

The ion exchange membrane bioreactor (IEMB) has shown to be effective in removing oxyanion contaminants (perchlorate, nitrate, chlorate) and heavy metals (Hg), from polluted groundwater both at low concentrations (Velizarov, S., et al. (2000) Mechanism of charged pollutants removal in an ion exchange membrane bioreactor: Drinking water denitrification. Biotechnology and Bioengineering 71 (4), 245-254.; A. D. Fonseca, et al., Drinking water denitrification using a novel ion-exchange membrane bioreactor, Environ. Sci. Technol. 34 (2000) 1557-1562.) and at high concentrations (Fox et al., 2014, Hazard. 264, J. Mat, 552-559, doi: 10.1016-/j. jhazmat. 2013.10.050). The basic arrangement of the ion-exchange membrane bioreactor involves two compartments, a feed water compartment, and a bio-compartment, separated by an ion exchange membrane, e.g., cation-exchange membrane or anion-exchange membrane, depending on the contaminant ionic nature, such as anion-exchange membrane in case of anionic contaminants, e.g., oxyanions. In such cases, anions added to the bio-compartment side, such as chloride ions, are used to drive the oxyanions from the feed water compartment across the anion-exchange membrane and into the bio-compartment, by a process known as Donnan dialysis. The oxyanions that cross into the bio-compartment are conveniently reduced by oxyanion-reducing bacteria residing in the bio-compartment, utilizing a carbon source and electron donor supplied to the bio-compartment. For example, it may be possible to remove oxyanions, e.g., perchlorate or nitrate, or also phosphate, using an IEMB in continuous stirred-tank reactor (CSTR) mode, with the flux being linear in the concentration range between 20-150 mg/L depending on the membrane chosen, e.g., Neosepta™ ACS (Tokuyama™ Soda, Japan), or PCA-100 anion exchange membrane (PCA™ GmbH, Germany) or FAD or FAS membrane (FumaTech™ GmbH, Germany.

Generally, water-treatment systems involve membranes accommodated in a variety of configurations; one noteworthy is a spiral wound configuration. The spiral-wound configurations have been realized in commercially available electrodeionization applications, available, such as from Dow™ Corporation (DOW™ Electrodeionization Modules, Model EDI-310), BWT (Septron™ products), which utilize anion-exchange resin, cation and anion exchange membranes driven by an electric potential difference. Similar configuration is also realized in commercially available membrane bioreactors, such as aerated membrane bioreactor (e.g., Emefcy™ SABR), utilizing aerating membrane and oxygen concentration gradient within the biofilm.

However, when spiral IEMB is designed and constructed so that the bio-side follows a coiled path (in either co-current or countercurrent flow with the feed side), when in use, it becomes problematic to extremely difficult to remove excess biofilm trapped on the membrane or between the spacer filaments. The conventional methods have their limitations. For example, two-phase flushing (i.e., flushing with a gas-liquid stream) within the coiled pathway leads to trapping of gas (air or nitrogen) at various positions of the coil. When rapid fluid flow is attempted to dislodge the excess biofilm, the long path length of the coil (reaching and at times exceeding 6 m) and the narrow clearances of the coil, particularly when partially clogged on the bio-side, result in large axial pressure drops. These high pressure drops that are necessary to flush the membrane may readily exceed the mechanical stability limits of the spiral (e.g., for Spiraltec™ spiral these limits are 1.5 bar gauge pressure on each side and 200 mbar pressure difference between the two sides of the contactor). These problems have probably limited hitherto the implementation of IEMB.

Therefore, there is the need in the art to provide a working scheme of IEMB that could be run uninterrupted for prolonged time intervals.

### SUMMARY

It has now been unexpectedly found that it is possible to extend the operation of the Donnan dialysis module coupled with oxyanion biotransformation, by conducting the dialysis in a contactor essentially in absence of a carbon source and preferably in absence of microbiota, and conducting the oxyanion biotransformation in coupled but separate bioreactor, without any significant loss of efficiency.

The contactor circuit from the bio-side may be recirculated into an operation tank, whereas the stream may be split to direct a portion thereof into a bioreactor for oxyanion biotransformation, wherefrom at least partially decontaminated stream, containing little or no carbon source, is returned into the operating tank or into the contactor.

As shown in the comparative Example 1 below, a spiral wound module with co-current flow achieved significant nitrate removal rates (7.2 g nitrate/m²/h-40%-85% in once-through and 90% removal in feed-and-bleed recycle). The nutrients and carbon source were fed directly to the receiving side of the spiral wound contactor. Yet, this method of operation lead to pressure drops on the bio-side due to buildup of the reducing biofilm on the receiving solution side of the membrane. The biofilm buildup required frequent stops for flushing and cumbersome offline air sparge to avoid clogging and the development of high pressure drops. Quite contrary thereto, as demonstrated in further appended examples, it was possible to operate the water treatment system with minimal interruptions for up to almost two months, that is, during the duration of the experiment. It is believed, without being bound by a particular theory, that under rational operation conditions and minimal maintenance, as described herein, the time span for operating of the technological arrangement as described herein will be limited only to the lifespan of the membrane.

Thus, provided herein a method of decontaminating water of oxyanions, said method comprising passing a contaminated water stream through a feed side of a contactor, said contactor comprising said feed side and a bio-side separated by a an anion-exchange membrane, passing decontaminating stream on said bio-side, said decontaminating stream comprising driving ions in a concentration sufficient to drive said oxyanion through said anion-exchange membrane from said feed side to said bio-side, to form oxyanion-rich decontaminating stream, passing at least a portion of said oxyanion-rich decontaminating stream through a bioreactor, wherein said bioreactor comprises microorganisms capable of metabolizing said oxyanion, and bionutrients comprising a carbon source, to form a bioreactor effluent, wherein said bioreactor effluent is substantially decontaminated from said oxyanion, and recirculating said bioreactor effluent through said bio-side of said contactor, wherein said bioreactor effluent and said decontaminating stream on said bio-side of said contactor are essentially free of said carbon source. In some embodiments, said contactor is a spiral membrane contactor. In some embodiments, said contactor has a channel height of between 0.5 mm to 2.5 mm on the feed side, and between 2.5 mm and 10.0 mm on the bio-side. In some embodiments, said passing of a contaminated water stream and said passing of said decontaminating stream are carried out in a co-current contacting pattern in said contactor. In some embodiments, said oxyanion is selected from the group consisting of nitrate, nitrite, perchlorate, chromate, arsenite, arsenate, bromate, selenate, and chlorate. In some embodiments, said anion-exchange membrane conducts less than 2 milliequivalents of sulfate anions per square meter per hour from 100 mg/L solution, versus a 50 milliequivalent solution of sodium chloride as driving ions. In currently preferred embodiments, said oxyanion is nitrate.

In some embodiments, said method further comprises recirculating at least a portion of said oxyanion-rich decontaminating stream via an operating tank, said operating tank being in liquid communication with said bio-side of said contactor. In some embodiments, said recirculating comprises transferring a stream from said operating tank into said bio-side of said contactor. In some embodiments, said passing at least a portion of said oxyanion-rich decontaminating stream through a bioreactor and said recirculating said bioreactor effluent through said bio-side of said contactor, are carried out via said operating tank.

In some embodiments, said method further comprises periodically or continuously monitoring at one or more points the process parameters comprising pH values, the temperature, the flow rates, the optical density at wavelength 600 nm (OD₆₀₀), the oxidation-reduction potential (ORP), and inlet pressures on the feed side and bio-side of said contactor. In some embodiments, said method further comprises combining said at least a portion of said oxyanion-rich decontaminating stream passing into said bioreactor, with a bio-makeup stream comprising said carbon source. In some embodiments, said bio-makeup stream further comprises buffering agents and salts comprising ammonium and trace elements, said trace elements comprising magnesium, calcium, manganese, molybdenum, and copper. In some embodiments, said bio-makeup stream has a pH sufficient to maintain the pH of said bioreactor effluent at between 6.4 and 8.0. In some embodiments, if an ORP value measured in said bioreactor effluent is more negative than-300 mV, said method further comprising combining said bio-makeup with an additional amount of said oxyanion, in said bio-makeup stream. In some embodiments, said method comprises maintaining the temperature of said bioreactor between 20 and 30 degrees Celsius. In some embodiments, said method further comprises extracting periodically or continuously a portion of said bioreactor effluent as a bio-bleed stream, wherein a volume said portion being between 50% and 100% of the volume of said bio-makeup stream.

In some embodiments, said bioreactor comprises porous bio-carrier media for carrying said microorganisms, wherein a surface area of said bio-carrier media is between 600 and 1000 square meters per cubic meter of media. In some embodiments, a dry weight of biomass comprising said microorganisms on said bio-carrier media is between 3 and 6 grams per square meter.

In some embodiments, wherein said method further comprises periodically flushing said bio-side of said contactor and/or said bioreactor, and wherein said periodically flushing has the periodicity of between once a week to once in three weeks for said contactor, and between once a month to in three months for said bioreactor. In some embodiments, said flushing of said bioreactor is conducted when said OD₆₀₀ measured in said bioreactor effluent is between 0.3 to 0.5.

In some embodiments, said driving ions are selected from the group consisting of chloride ions or bicarbonate ions. In some embodiments, said concentration sufficient to drive said oxyanion through said anion-exchange membrane is between 40 and 10 mmol of said driving anion per 1 mmol of said oxyanion.

In some embodiments, the method is wherein said oxyanion is nitrate, said contaminated water stream comprises between 50 and 300 mg per liter of nitrate, wherein said driving ions are chloride, said decontaminating stream comprises 50 to 200 milliequivalents of chloride, wherein said recirculating at least a portion of said oxyanion-rich decontaminating stream is performed via an operating tank, wherein said contactor is a spiral membrane contactor, wherein said bio-makeup stream contains sufficient amount of said carbon source and said oxyanion, and a pH value, to maintain the ORP value between −140 mV and −290 mV, and said pH value between 6.4 and 8.0, wherein the operational parameters of said method are selected from the group consisting of a) the flow rate of said contaminated stream is between 30 and 80 liters per hour, b) the flow rate of said decontaminating stream is between 40 and 120 liters per hour, c) the volume of said bioreactor is between 20 and 30 liters and said bioreactor being filled at between 12 and 18 liters with a biocarrier media having a surface area of between 600 and 1000 square meters per cubic meter, d) the flow rate of said at least a portion of said oxyanion-rich decontaminating stream passing through said bioreactor is between 15 and 35 liters per hour, e) the flow rates of said bio-makeup stream and said bio-bleed stream are individually and independently between 2 and 5 liters per hour, and a combination of any of these operational parameters, such that said operational parameters correspond to said contactor having a path of between 5-7 meters and membrane surface area of between 2.5 to 3 square meters, or adjusted to corresponding proportional values, and wherein the periodically flushing of said contactor has the periodicity of between once a week to once in three weeks, and wherein the periodically flushing of said bioreactor has the periodicity of between once a month to once in three weeks.

In a further aspect, provided herein a system for water treatment operating according to a method as described generally herein.

In a further aspect provided herein a system for water treatment comprising a contactor for contacting a contaminated water stream comprising an oxyanion as said contaminant, said contactor comprising a feed side, and a bio-side, separated by an anion-exchange membrane, and a bioreactor comprising microorganisms capable of metabolizing said oxyanion, wherein said bioreactor is in liquid communication with said bio-side of said contactor. In some embodiments, said system further comprises means for feeding said contaminated stream into said contactor on said feed side, and means for discharging at least a portion of purified contaminated stream from an outlet of said feed side of said contactor. In some embodiments, the system further comprising means for recirculating said contaminated stream between an outlet of said feed side of said contactor and an inlet of said feed side of said contactor, optionally via a process feed tank, said process feed tank being in liquid communication with an inlet of said feed side of said contactor and said outlet of said feed side of said contactor. In some embodiments, the system further comprising a bio-side operating tank in liquid communication with an inlet of said bio-side of said contactor and an outlet of said bioside of said contactor. In some embodiments, further comprising means for feeding a decontaminating stream into said contactor on said bio-side, means for recirculating said decontaminating stream between an outlet of said bio-side of said contactor and an inlet of said bio-side of said contactor. In some embodiments, the system further comprising means for recirculating said decontaminating stream through said bioreactor. In some embodiments, said means for recirculating said decontaminating stream through said bioreactor are in liquid communication with said operating tank and said bioreactor.

### BRIEF DESCRIPTION OF THE DRAWINGS

FIG. 1 schematically demonstrates a further basic arrangement of the ion-exchange membrane bioreactor (IEMB) which is prone to clogging, in once-through feed pattern.

FIG. 2 schematically demonstrates the basic arrangement of the ion-exchange membrane bioreactor (IEMB) which is prone to clogging, as used in the comparative Example 1, in which the biofilm forms on the bio-side of the Donnan contactor, with recycling setup of the feed.

FIG. 3 schematically demonstrates a technological arrangement according to an embodiment of the present invention, as elaborated below.

FIG. 4 presents a chart of historical data of running the fixed bed bioreactor to increase its biodegradation capacity before connecting to the bio-side loop of the IEMB membrane contactor in the Example 3. NLR is nitrogen loading rate relative to volume of the bioreactor.

FIG. 5 presents a chart of pressure drop on the bio-side of the contactor in experimental run described in Example 3.

FIG. 6 presents a chart of sulfate ions permeation through several membranes by Donnan dialysis.

FIG. 7 presents denitrification data obtained according to an embodiment of the invention.

FIG. 8 presents a chart plotting the ORP versus the denitrification efficiency according to an embodiment of the invention.

FIG. 9 presents a chart characterizing the effect of carbon source to nitrate ratio on the denitrification efficacy according to an embodiment of the invention.

### DETAILED DESCRIPTION

Therefore, in a first aspect, provided herein a method of decontaminating water of oxyanions. Preferably, the oxyanions to be decontaminated are selected from the group consisting of nitrate, nitrite, perchlorate, chromate, arsenite, arsenate, bromate, selenate, and chlorate. Currently preferably, the oxyanion is nitrate. The method comprises passing a contaminated water stream through a feed side of a contactor comprising the feed side and an opposing bio-side separated by an anion-exchange membrane, and concomitantly passing a decontaminating stream on the bio-side of the contactor, such that the decontaminating stream comprises driving ions in a concentration sufficient to drive the oxyanions through the anion-exchange membrane of the contactor from the feed side to the bio-side. This way, an oxyanion-rich decontaminating stream is formed, and forwarded at least partially through a bioreactor that comprises microorganisms capable of metabolizing the extracted oxyanions. The bioreactor also comprises bio-nutrients, e.g., a carbon source, salts, and/or micronutrients, to sustain the microorganisms, preferably supplied therein together with or separately from the oxyanion-rich stream. The microorganisms metabolize oxyanions to a certain extent, preferably, to over 80% of the oxyanion supplied into the bioreactor. A stream is drawn from the bioreactor, i.e., a bioreactor effluent, and it is preferably substantially decontaminated from the oxyanion, as described herein. The bioreactor effluent may then be recirculated through the bio-side of the contactor to drive out more oxyanions. In this arrangement the bioreactor effluent and, even more preferably, the decontaminating stream on the bio-side of the contactor, are essentially free of said carbon source, thereby suppressing biofouling and clogging of the contactor.

Referring now to FIG. 1, wherein the technological arrangement for ion-exchange membrane bioreactors in once-through mode, as known in the art, is discussed. The arrangement is divided in theoretical bio-side, denoted “BIO”, and the feed side, denoted “FEED”. The IEMB A contains the ion-exchange membrane, through which the oxyanion, exemplified by nitrate, is permeated, denoted by “J_{NO3}”. The raw feed, denoted as “Raw feed”, from raw feed container D, is supplied at a controlled rate via pump P3, into process feed container C, denoted as “Process Feed”. Stream 1 is forwarded from the process feed container C via pump P2 into the feed side of the IEMB A. A decontaminated stream 2 exits the IEMB A, into the treated feed container (not shown), denoted “Treated Feed”. On the bio-side, the operating tank B, denoted “Operating tank”, produces a stream 3i via pump P4 into the bio-side of the IEMB A. A stream of driving ions and bionutrients 4 is provided into the stream 3i or directly into the IEMB A, by means of pump P1 from the driving ions and biomakeup container, denoted as “driving ions and bionutrient makeup”. The bio-side effluent from the IEMB A (stream 30) is recycled into the operating tank B. The advantage of the known configuration is that the permeating oxyanion is transformed in the vicinity of the membrane, thereby increasing the concentrations' gradient. Evidently, the significant drawback is the clogging of the bio-side of the IEMB and the need for time-consuming, elaborate, and meticulous maintenance, which may not be possible due to mechanical properties of the membrane module.

It has now been unexpectedly found that utilizing the technological arrangement as described herein may increase the uninterrupted operation span without any significant loss of efficiency. Conducting Donnan dialysis in a contactor essentially in absence of a carbon source and conducting the oxyanion biotransformation in a separate coupled bioreactor, whereas apparently increasing the initial set-up and maintenance cost, proves an efficient way to uninterrupted operation of the water treatment arrangement, which compensates manyfold for any added collateral cost.

Moreover, when an operating tank is employed in the technological arrangement, the decontamination of the feed stream in the contactor may be advantageously performed at the operational parameters optimized for the Donnan dialysis, and the biodegradation of the extracted oxyanions may be performed in a separately controlled bioreactor at the operational parameters optimized for oxyanion reduction efficiency. Apart from physical separation of microbiota from the contactor, the technological arrangement allows for optimization of each process separately, contributing to the efficiency of the process. Thus, the method may further comprise recirculating at least a portion of the oxyanion-rich decontaminating stream via an operating tank, while the operating tank being in liquid communication with the bio-side of said contactor. The recirculating also comprises transferring a stream from the operating tank into the bio-side of said contactor. Moreover, the passing of at least a portion of the oxyanion-rich decontaminating stream through a bioreactor and the recirculating of the bioreactor effluent through the bio-side of the contactor, may also be carried out via the operating tank.

Therefore, the bio-side output from the contactor may be accumulated in an operating tank, wherefrom a stream is withdrawn to a bioreactor. Alternatively, a side stream may be withdrawn from the return stream from the bio-side output from the contactor, upstream of the operating tank, and fed to a bioreactor. Nutrients and carbon sources are provided into the stream entering the bioreactor, and therefore the bioreactor output, essentially devoid of carbon source, is being recirculated into the operation tank. The liquid from the operation tank is recirculated into the ion-exchange contactor, having the driving ions added before entering the contactor. Alternatively, the driving ions may be added together with the bio-makeup. This way the conditions for formation of the biofilm anywhere apart from the bioreactor are unfavorable and little biofilm is accumulating on the bio-side of the contactor, allowing the uninterrupted operation time to be significantly increased, and easy dislodging of any created biofouling at lower pressures during routine maintenance. Whereas it is acknowledged that the concentration gradients of the oxyanions through the membrane may diminish slightly due to this arrangement, that is, due to absence of oxyanion-processing microbiota straight on the membrane, as some untreated oxyanion may be recycled into the contactor, but, as mentioned above, the absence of (or a slowly forming) biofouling of the membrane maintains and compensates manyfold any loss in the efficiency.

The driving ions usually readily cross the anion-exchange membrane and create the driving force for the diffusion of the contaminant oxyanions to the bio-side. These driving ions are preferably selected from the group consisting of chloride ions, bicarbonate ions and sulfate ions. Currently preferably, the driving ions are chloride ions. The concentration of the driving ions is usually sufficient to drive the oxyanion through the anion-exchange membrane, whereas the exact concentration will be dependent on many parameters, such as the nature of the driving ions and the membrane, the flow rates through the contactor, contactor path length and other parameters such as space time given by feed path length divided by feed flow velocity. Preferably, the concentration of the driving ions is between 10 and 40 mmol of said driving anion per mmol of said oxyanion.

The term “ion-exchange membrane” and the like as used interchangeably herein, in their most general form should be construed as comprising anion-exchange membranes or cation-exchange membranes depending on the charge of the species being separated. The ion exchange membrane, e.g. an anion exchange membrane or a cation-exchange membrane, may be any membrane satisfying the requirements of the IEMB, such as low permeability to carbon source or to the microbiota, and selective permeability to ions, fabricated of any material known in the art, such as, but not limited to, polymers with polystyrene or polyaliphatic backbones to which charged functional groups are attached. Preferably, the membrane is anion-exchange membrane, particularly as far as the oxyanion decontamination is concerned. For the anion-exchange membranes, the functional groups may comprise quaternary ammonia or tertiary and secondary amine groups; for cation-exchange membranes, the functional groups may comprise sulfonic groups.

The exemplary anion-exchange membranes suitable for the present invention include aliphatic polymers containing tertiary and quaternary amines with or without reinforcement, commercially available from a variety of manufacturers. In one particular embodiment membranes were used from the PC-Cell company under trade name of PCA-100, or from aromatic crosslinked polymers (e.g., polystyrene) containing tertiary and quaternary amines with or without reinforcement, commercially available from a variety of manufacturers. Examples of the currently available anion-exchange membranes and their respective manufacturers are ACX and AMX (Astom™ corporation), FAS, FAD and FAB (FumaTech™ GmBH), and AMV (Asahi™ Glass Ltd.). Some exemplary cation-exchange membranes suitable for the present invention include membranes that may have an aliphatic backbone with negatively charged groups, commercially available, e.g., from PC-Cell. Alternatively, the cation exchange membrane may have aromatic backbone (e.g., polystyrene) with negatively charged groups on the backbone, commercially e.g., variety of available, manufacturers, examples being CMS, CSE-W and CMX (Astom™ corporation), FKS, FKD and FKE (FumaTech™ GmBH), and CMV (Asahi™ Glass Ltd.). Other characteristics of the ion-exchange membranes will become apparent from the discussion below.

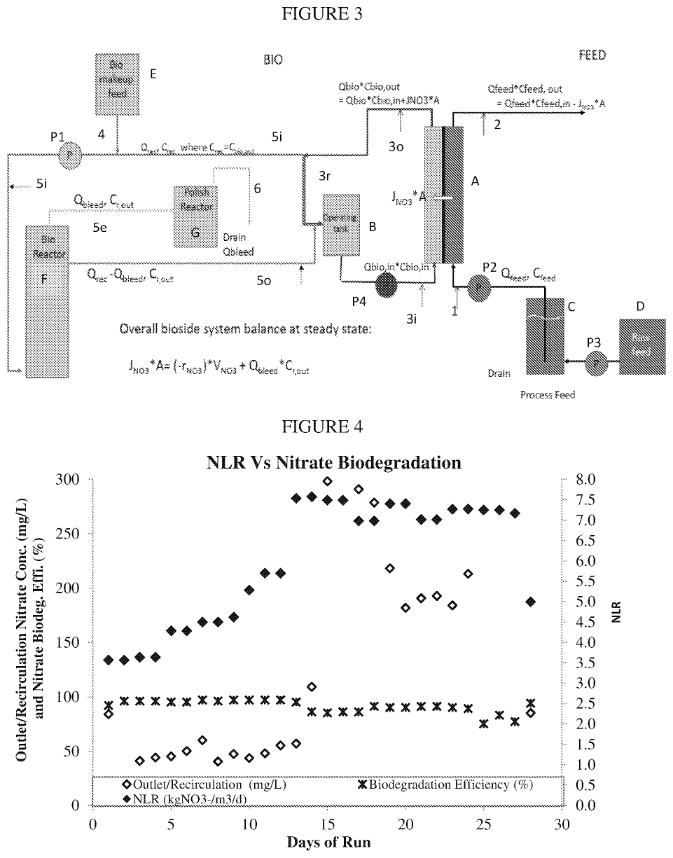

The spiral-wound contactor module may be used of any suitable configuration as known in the art. For example, a spiral-wound module as disclosed in European Patent application EP3317001 may be used. This way coaxial co-current or counter-current flow modes may be employed. Alternatively, the flow channel in the spiral module will be composed of an ion exchange membrane and an impermeable foil coiled in such a way that the sleeve is coiled back on itself at the outer circumference of the coil as described in FIGS. 3 and 4 and 5 of WO2017/001060A1, all the content whereof is incorporated herein by reference. In this design both the inlet and outlet channels to the coiled spiral are located in the vicinity of the center of the coil.

As mentioned in brief above, regardless of the flow pattern, as used herein, the side of the contactor receiving the contaminated water is termed “feed side” or “contaminated feed side”, and the contralateral side of the contactor is termed herein “bio”, “bio-side compartment”, “dialysis compartment”, “receiving compartment” and the like, despite the fact that no biofilm is purposely planted on this side, but to denote that streams from this side ultimately reach at least one bioreactor.

The spiral-wound element may further comprise spacers to separate the adjacent layers, i.e., the windings of the spiral, to provide a defined space for flow of the streams. The spacers may be in form of a mesh, formed from spacers such as those used as feed spacers in spiral wound reverse osmosis modules, in which the filaments of the spacers form a diamond pattern (flow direction makes angle at 30-60 degrees with the filament), or ladder spacers (larger diameter filaments are parallel to flow direction and cross filaments are at 90 degrees to flow direction), or helical filaments whose axes are parallel to flow direction without cross filaments. The filaments can be submerged in the flow channel or flush against the membrane surface. The thickness of the spacers would be between 0.7-5 mm, and may be prepared of any suitable material, such as, but not limited to, polypropylene, polyethylene, and their blends.

The rolled-up envelope may have a width at least 5 cm or more, and preferably about 10-100 cm. The length of the envelope may be at least 1 m, e.g., between 1 and 5-6 m. Several such spiral wound elements can be configured in series if a longer path length is needed for the water side. In such series the water effluent from an upstream spiral may be fed to the next spiral module in the series as inlet (contaminated) water stream. The driving ions may also be provided at entrance to every spiral module.

Thus, according to a preferred embodiment, the method comprises a contactor which is in a spiral membrane configuration. The spiral membrane contactor has a feed side and a bio-side. In an exemplary embodiment, the membrane forming the compartments divides the module into the two sides: the feed side (supplying the contaminated solution) and the bio-side (contaminant-receiving solution). Each side of the contactor is connected to the outside by at least one inlet and at least one outlet ports, so that there are at least total of four ports. Preferably, the contactor has a channel height of between 0.5 mm to 2.5 mm on the feed side, and between 2.5 mm and 10.0 mm on the bio-side. The channel height is usually provided by a thickness of spacers used in the contactor module, inter alia, as described in the appended examples.

The flow pattern may generally be concomitant or intermittent counter-current or co-current, but it is currently preferred that the flow pattern of the streams in the feed side and in the bio-side is co-current, that is, that the streams in the two compartments flow in the same direction at the same time from their respective inlets to their respective outlets.

As mentioned above, at least a portion of the oxyanion-rich decontaminating stream is directed into a bioreactor. The bioreactor may be a continuously stirred tank reactor (CSTR) with suspended or a supported biofilm (e.g., moving bed bioreactor), or it can be a supported biofilm with plug-flow reactor (PFR) contacting pattern (e.g., fixed bed or fluidized bed bioreactor). Therefore, biofilm forms in bioreactor and not on the membrane of the contactor.

The volume and/or the capacity of the bioreactor will be dependent on the needs of the process and on the recirculation rate. Some exemplary volumes and operational parameters are discussed below. The bioreactor may usually be a vertically or angularly disposed vessel, equipped with at least one inlet and at least one outlet, which may be positioned at a bottom and at a top side, respectively, of the bioreactor vessel. The bioreactor may be partially filled with beads to support the formation of the biofilm and to affect the flow. The bioreactor may also contain a gas inlet and a gas outlet for a variety of purposes, e.g., for introducing an inert gas if anaerobic conditions are required, or to periodically flush the bioreactor bed from excess biomass, or to evacuate the evolving gas from the reduced contaminants, e.g., nitrogen from nitrates. Some additional configurations for bioreactors and general guidelines for their exploitation may be found, inter alia, in Metcalf and Eddy, Wastewater Engineering-treatment and resource recovery, 5^{th} ed. (2014), chs 7-10.

For fixed-bed bioreactors, the bioreactor may further comprise beads, referred to interchangeably herein as “bio-carrier media”, for carrying the microorganisms. The bio-carrier media may usually be a plurality of porous or hollow parts with a large surface area exposed, relatively to the volume of the material of the bio-carrier media. The bio-carrier media pieces may be, for example, of essentially cylindrical configuration, supported by an internal cross-shaped core, with the dimensions of several centimeters. The bio-carrier media may also have a corrugated surface, facilitating the attachment of the biofilm, but providing a low flow resistance due to the hollow body structure. Exemplary bio-carrier media are available from Aridal Bioballs™, Israel. The porosity of the bio-carrier may be between 50 and 90% of the plan dimensions, e.g., between 75% and 85%. The surface area of the bio-carrier media is therefore rather high, e.g., between 300 and 1500 square meters per cubic meter of media, preferably between 600 and 1000 m²/m³. The bulk density of the bio-carrier media may thus be dependent on their surface-to-volume ratio, on their plan dimensions, and on the material the bio-carrier media are manufactured from. Depending on these parameters, the bio-carrier media may have the bulk density of between 90 and 250 kilograms per cubic meter, preferably between 150 and 200 kg/m³.

The biomass evolving in the bioreactor may be controlled to maintain a stable oxyanion conversion rate, but to avoid overgrowth and biofouling of the downstream appliances, significantly, the contactor. For fully developed and acclimatized bioreactor, the biomass may be maintained within the limits of between about 2 and about 7 grams of dry biomass per square meter of the bio-carrier media, preferably, between 3 and 6 g/m². To control the biomass, the bioreactor may be periodically flushed with air, inert gas, water, or suitable chemicals, such as hydrogen peroxide or sodium hypochlorite solution at 0.05-0.2% w/v, to detach and remove the excess of biomass. To determine the threshold conditions for flushing the bioreactor, it may be beneficial to monitor the optical density at 600 nm wavelength of the bioreactor effluent, and once it reaches the OD₆₀₀ of between 0.3 to 0.5, the flushing may be prescribed. Generally, the flushing of the bioreactor and/or the contactor may still be performed in framework of routine maintenance procedures, but with the periodicity of significantly rarer that would be required for IEMB configuration with biofilm developing in the contactor. The periodicity of flushing/maintenance of the bioreactor and/or the contactor may be selected between once a week to once every three months. An alternate embodiment can be to place a microfiltration or ultrafiltration module on the bioreactor outlet to prevent suspended biomass swept out of the bioreactor from reaching the contactor. The bioreactor may be flushed with a periodicity of between once a month to once every three months. As described in the examples below, the flushing of the contactor may be performed at a periodicity of between once a week and once in three weeks, preferably once in about 10 days to 18 days.

Typical composition of the bioreactor liquid, interchangeably herein referred to as a “biosolution” or “bio-makeup”, comprises at least one biofeed, e.g., comprising a compound digestible by the microbiota, providing it the carbon and electron source (e.g., glycerol, ethanol). The bio-makeup may further comprise trace phosphate and trace nitrogen source, and a buffering agent. Thus, the bio-feed provides the source of carbon and energy for the biofilm in the reactor. The buffers may be any microbiologically acceptable and/or stable salts, e.g., phosphates. The pH of the bio-feed may be adjusted using mineral acids and solutions of alkali metals or ammonia, e.g., sulfuric acid, phosphoric acid, hydrochloric acid, and sodium hydroxide, potassium hydroxide or ammonium hydroxide. The bio-feed may also comprise magnesium, e.g., as sulfate salt, ammonium, e.g., as chloride salt, and a variety of trace elements, including salts of copper, iron, manganese, and molybdenum.

As described below, the bio-makeup may also further comprise an additional amount of oxyanion, e.g., to control the eco-balance of the microbiota in the bioreactor, by the way of example, to suppress sulfate-metabolizing microorganisms. The bio-makeup may also comprise the driving ions, provided they do not significantly interfere with the bioreactor conditions. This way the bioreactor effluent may be made suitable for recirculation into the contactor without further process steps.

When glycerol is used as a carbon source, it may be introduced in amounts of between 0.08-0.4 g/L in the entrance to the bioreactor, preferably between 0.1 and 0.3 g/L. Generally, if nitrate is the oxyanion to be removed, the amount of glycerol will be stoichiometric if supplied 5/14 mmol per 1 mEq of nitrate that crosses the membrane. As demonstrated in the appended examples, the amount of glycerol as an example of carbon source, may affect the efficiency of oxyanion removal, and should be kept between 75% and 125% of the stoichiometric amount of carbon source needed. More preferably, the amount of glycerol as an example of carbon source needed to maintain the efficiency of oxyanion removal is between 90% and 100% of the stoichiometric amount. Amount of between 100% and 125%, e.g., slight excess, may be used in acclimatizing of the bioreactor, to maximize the bioconversion and expedite the equilibration of the bioreactor. It is believed, however, that carbon source traces should not be present in the bioreactor effluent during the operation of the technological arrangement, to minimize the biofouling of the contactor membrane. When ethanol is used as the carbon source, the amount to be supplied which will be stoichiometric 2.5 mmol per 1 mEq of nitrate that crosses the membrane. When glycerol is used with perchlorate, then 4/7 mmol of glycerol will reduce 1 mmol of perchlorate.

The bio-makeup stream may be fed into the bioreactor separately from the oxyanion-rich decontaminating stream from the contactor. Therefore, the method may further comprise combining the portion of the oxyanion-rich decontaminating stream passing into the bioreactor, with a bio-makeup stream comprising said carbon source. Alternatively, the bio-makeup may be injected directly into the stream entering the bioreactor. Therefore, as described above, the bio-makeup stream may comprise, additionally to carbon source and optionally an additional oxyanion supplement, buffering agents and salts comprising ammonium and trace elements, the trace elements comprising magnesium, calcium, manganese, molybdenum, and copper.

The bioreactor may usually be maintained at a temperature suitable for the microorganisms inoculated therein, e.g., between 20° C. and 35° C., preferably between 25° C. and 30° C. The temperature may be controlled by suitable heating elements, e.g., by a double-jacket assembly on the bioreactor. Alternatively, the temperature may be controlled by controlling the temperature of the incoming streams into the bioreactor through an external heat exchanger.

The bioreactor is usually acclimated before being used in the process according to the invention. The acclimation may include seeding the microbiota and growing it in the bioreactor in presence of the oxyanion to be degraded, for sufficient time to obtain stable biofilm producing reproducible consumption rate of the oxyanion. The duration of the acclimation may be between 24 hours to two weeks.

The microbiota of the bioreactor may be extracted from soils or other media contaminated with at least one contaminant, e.g., an oxyanion, intended for separation. The culture may also contain microorganisms extracted from aquaculture sludge. The cultures may be grown in suitable conditions, e.g., anaerobic or anoxic conditions, to concentrations as known in the art, before inoculating the bioreactor; the growth medium comprises the at least one contaminant, e.g., oxyanion, and the intended carbon source, e.g., glycerol or ethanol. Additionally, the microbiota may be sampled before the inoculation and/or during the process, to detect and quantify the oxyanion-processing genes. The genetic analysis may be performed as known in the art, e.g., by polymerase chain reaction (PCR) or any of the method's improvements. For example, when the oxyanion is nitrate, the genes sampled by PCR may include nirs, nirk, dsr1, dsrA and 16S rRNA (Accession numbers: EF052878.1 for dsrA and AM 493693.1 for dsr1). Likewise, pcrA and clrA can be used for quantifying perchlorate and chlorate reducing bacteria respectively, as known in the art.

The bio-side compartment and the contaminated water compartment, as well as the bioreactor(s), may be monitored periodically, e.g., at their respective inlets and outlets, and optionally at specific sampling points. The parameters that may be monitored are the contaminant, e.g., oxyanion concentrations, the bio-feed concentration, the flow rates, the total organic carbon (TOC), pH, total phosphate, the optical density at wavelength 600 nm (OD₆₀₀), and the oxidation-reduction potential (ORP) as well as the concentration of the driving ion. The parameters may be monitored as generally known in the art, e.g., as described in the examples below.

ORP is an indicator of anoxic environment inside the reactor, which may be required for effective decontamination of certain oxyanions, e.g., nitrate. The value of ORP is commonly believed to be required in the range of +50 mV to −350 mV for denitrification. A higher positive value indicates the presence of elevated concentration of nitrate while higher negative value signifies the reduced level of residual nitrate during the denitrification process. In addition, the variation of ORP values also depends on the availability of carbon and whether the donor/acceptor ratio exceeds or falls short of the stoichiometric ratio during any stage of denitrification. A higher donor/acceptor ratio accelerates the heterotrophic denitrification by inducing fermentation of substrate (anaerobic like conditions), resulting diminishing concentration of residual nitrate while balanced donor/acceptor ratio specifies the optimum denitrification, reducing maximum nitrate present in t the system while maintaining the anoxic conditions. ORP is conveniently measured by dedicated electrodes well known in the art and readily available on the market. However, as demonstrated in the appended examples, it has been unexpectedly found that the ORP values in the present technological arrangement corresponding to efficient denitrification are preferably between negative 110 mV (−110) and negative 300 (−300) mV.

As described above, at least part of the bio-side compartment contents of the contactor may be recirculated into an operating tank. Generally, the flow from the contactor is rich in oxyanions. The stream from the contactor may be at least partially withdrawn into the bioreactor, to effect the biotransformation of the oxyanions. The purified stream (or at least partially purified stream) from the bioreactor is returned into the operating tank, or, if significant excesses are formed, can be polished in a separate reactor, and drained. Therefore, the method may further comprise extracting periodically or continuously a portion of the bioreactor effluent as a bio-bleed stream, such that a volume the bio-bleed stream portion being between 50% and 100% of the volume of the bio-makeup stream, adjusted according to the needs of the process.

The recirculated stream from the operating tank into the contactor may then be fortified with driving ion source, e.g. sodium chloride, to enable the driving ions, e.g., chloride ions, to drive the oxyanions from the contaminated water stream to the bio-side compartment. The chloride ion source may be mixed with the recirculated stream or may be added separately or consecutively with the recirculating stream. Alternatively or additionally, as described above, the driving ions may be added into the stream fed to the bioreactor.

The rate of the recirculation between the contactor and the operating tank(s) will be dependent on the volume of the contactor and the tank(s), the tubing, and other structural parameters of the system. By the way of example, in a system when the oxyanion is nitrate, the contaminated water stream (the feed stream) comprises between 50 and 300 mg per liter of nitrate, the driving ions are chloride and the decontaminating stream comprises 50 to 150 milliequivalents of chloride, the recirculating at least a portion of said oxyanion-rich decontaminating stream is performed via an operating tank, the contactor is a spiral membrane contactor, the bio-makeup stream contains sufficient amount of the carbon source and the oxyanion to maintain the ORP value between −140 mV and −290 mV, and has a pH value between 6 and 8.5, e.g., between 6.4 and 8.0, the operational parameters corresponding to contactor having a path of between 5-7 meters and membrane surface area of between 2.5 to 3 square meters, may be selected from the group consisting of a) the flow rate of said contaminated stream is between 30 and 80 liters per hour, b) the flow rate of said decontaminating stream is between 40 and 120 liters per hour, c) the volume of said bioreactor is between 20 and 30 liters and said bioreactor being filled at between 12 and 18 liters with a biocarrier media having a surface area of between 600 and 1000 square meters per cubic meter, d) the flow rate of said at least a portion of said oxyanion-rich decontaminating stream passing through said bioreactor is between 15 and 35 liters per hour, e) the flow rates of said bio-makeup stream and said bio-bleed stream are individually and independently between 2 and 5 liters per hour, and a combination of any of these operational parameters, or adjusted to corresponding proportional values for a different contactor length/surface area. Particularly, in this configuration, the periodically flushing of the contactor may have the periodicity of between once a week to once in three weeks, preferably once every two weeks, e.g., between 10 and 18 days. The periodically flushing of the bioreactor may have the periodicity of between once a week to once in three months, preferably between once in 50 to 70 days, e.g., about once in two months.

During the long-term exploitation of the bioreactor a certain sulfate amount may accumulate in the bio-side. The sulfate sources may include the bio-makeup components, and more importantly, the sulfate ions co-permeating from the feed side. The sulfate ions excess may upset the equilibrium in the bioreactor due to overgrowth of sulfate-reducing microbiota. Thus, as demonstrated in the examples below, when the ration of nitrate to sulfate in the bioreactor drops to 0.2, the excessive sulfate-reducing overgrowth is observed with no nitrate consumption. Increasing the ratio to at least 0.6 suppresses sulfate reduction, and at ratios above 1, e.g., at 1.2, nitrate reduction rate reached 92%. Therefore, several steps may be taken to minimize the risk of bioreactor upset.

One such measure may be using an anion-exchange membrane that has low permeability to sulfate, yet sufficient permeability to other oxyanions, such as nitrate. Such exemplary membranes, as demonstrated below, may be FAS or FAB membranes, manufactured by FumaTech GmbH, which are recommended by the manufacturer for electrodialysis applications, whereas FAD membrane, designated specifically for Donnan dialysis, has been found particularly permeable to sulfate. Therefore, in some preferred embodiments, the anion-exchange membrane is selected such that it conducts by Donnan dialysis less than 2.0 milliequivalents of sulfate anions per square meter per hour, from a solution having sulfate concentration of 100 mg/L, versus a 50 milliequivalent solution of sodium chloride as driving ions, particularly, if the oxyanion is nitrate.

A further measure is providing higher oxyanion loading to suppress sulfate bio-reduction. Therefore, when a sulfate-reducing upset in bioreactor is suspected, additional target oxyanion may be added into the bio-makeup to restore the balance. As an additional measure, the pH value may be controlled, e.g., by supplying acid or alkali into the bio-feed and/or the oxyanion-rich decontaminating stream, to maintain the bioreactor effluent at pH values between 6 and 8.5, e.g., between 6.4 and 8.0.

Additionally, maintenance may be performed. The maintenance may include draining the bioreactor, optionally flushing the bioreactor with water, and restarting the bioreactor with increased supply of oxyanion. The tubing of the bio-side may also be flushed with tap water or disinfection solution, e.g., hydrogen peroxide or sodium hypochlorite solution, at 0.05-0.2% w/v.

To monitor the process, as described above, a variety of methods may be employed. One particularly useful in respect of monitoring the bioreactor upset and the homeostasis is the oxidation-reduction potential. The electrode measuring the ORP may be advantageously installed at the bioreactor effluent stream, and its values may be used to interpret the efficiency of oxyanion bioconversion and/or the danger of bioreactor upset and overgrowth by intervening microbiota. Thus, for example, when the oxyanion is nitrate, an ORP value measured in the bioreactor effluent being more negative than −300 mV may be indicative of shift to strictly anaerobic conditions and sulfate-reducing overgrowth. The values of more positive than −110 mV, on the other hand, may indicate inefficient nitrate conversion. Therefore, the method may comprise measuring the ORP values, preferably in the bioreactor effluent, and if the ORP value measured in the bioreactor effluent is more negative than −300 mV, the method may further comprise combining the bio-makeup with an additional oxyanion in the bio-makeup stream, e.g., to suppress sulfate-reducing overgrowth. If ORP values are less negative than −110 mV, then the rate of supply of carbon source (e.g., glycerol) may be increased to bring it to values of −110 mV or more negative.

Referring now to FIG. 3, wherein an embodiment of the present invention is demonstrated. The explanation of the notation on the labelling of the streams and the associated values in the figure, is provided in the table 1 below. The bioreactor (F) is placed on a side stream (5) diverging from the recirculating bio-side solution (3) returning from the spiral contactor A outlet to the operating tank. The raw feed flow, containing contaminated water, is provided, e.g., by a pump P3, from raw feed container D, denoted as “Raw feed”, to the process feed reservoir C. Denoted as “Process Feed”. From the process feed reservoir C, the contaminated stream (1), denoted also as “Qfeed, Cfeed”, is fed into the ion-exchange contactor A, by means of a controllable pump P2, to maintain a desired flow rate and/or to maintain a specific pressure at the outlet of the feed side of the contactor A. During the passage through the feed side, the oxyanions, exemplified by nitrate in the figure, denoted as “J_{NO3}*A”, are transferred to the bio-side, at a rate equal to the average transmembrane flux multiplied by the area of the membrane. On the bio-side, the feed is supplied from the operating tank B via a controlled pump P4, and driving ions contained therein, e.g., chloride, is provided into the stream (3i), also denoted as “Qbio, in*Cbio, in”. The stream leaving the contactor bio-side (3o) (which may be regarded as decontaminating stream) is rich in oxyanion, denoted also as “Qbio*Cbio, out=Qbio*Cbio, in+J_{NO3}*A” in the figure. The decontaminating stream (3o) is then split into two streams (5i and 3r) according to the needs of the process, with a first stream (3r), which may be regarded as recirculated decontaminating stream, with 3r being fed into the operating tank B, whereas the rest of the decontaminating stream (5i), denoted also as “Qrec,Crec where Crec=Cbio, out”, is fed into the bioreactor, e.g. by the means of a pump P1. An intermediate buffering tank (not shown) may be placed to accumulate the decontaminating stream before entering the bioreactor. The bionutrient components may be added (stream 4) to the decontaminating stream, e.g. in the buffering (biomakeup feed) tank E, denoted as “Bio makeup feed”, or directly into the stream. Alternatively, the bionutrient components may be supplied directly into the bioreactor. The residence time in the bioreactor will be governed by the flow pattern inside the bioreactor and the composition of the effluent. The bioreactor effluent (5) will normally be devoid of carbon source from the biofeed. Depending on the needs of the process, a portion of the bioreactor effluent (Qbleed) may be fed into polishing reactor G as stream (5e), denoted also as “Qbleed, Cr, out”, before draining the excess water (stream 6), denoted as “Drain Qbleed”, originally introduced in the biomakeup stream, while the remainder of the bioreactor effluent (stream 5o, also denoted as “Qrec-Qbleed, Cr, out”) is recirculated into the operating tank B. The bioreactor effluent may also be passed through a settling tank (not shown), to decrease the bioload of the bioreactor effluent prior to entry into the operation tank or through an ultrafilter to remove all remaining suspended solids.

TABLE 1
Explanation of notation in FIG. 3.

| Sign | Explanation | Stream # |
|---|---|---|
| Qfeed | Volumetric flow rate on the feed side of the | 1 |
| | spiral, L/h | |
| Qbio | Volumetric flow rate recirculating through the | 3i |
| | bio-side of the spiral, L/h | |
| Qrec | Volumetric flow rate in the side loop leaving | 5i |
| | the bio-side return line from the spiral and | |
| | entering the bioreactor (5) | |
| Qbleed | Volumetric flow rate of effluent leaving polish | 5e and 6 |
| | reactor to drain (6) | |
| Cfeed, in | Concentration of nitrate in the feed side inlet | 1 |
| | to spiral, meq/L | |
| Cfeed, out | Concentration of nitrate in the feed side | 2 |
| | outlet from the spiral (2), meq/L | |
| Cbio, in | Concentration of nitrate in the bio-side inlet to | 3i |
| | spiral, meq/L | |
| Cbio, out | Concentration of nitrate in the bio-side outlet | 3o |
| | from the spiral, meq/L | |
| Cr, out | Concentration of nitrate stream exiting the | 5o |
| | bioreactor (F), meq/L | |
| Crec | Concentration of nitrate in stream entering the | 5i |
| | bioreactor | |
| J_{NO3} | Flux of nitrate ion across the membrane, | |
| | meq/h/m2 | |
| A | Membrane area of spiral contactor, m2 | |
| −r_{NO3} | Average volumetric nitrate reduction rate in | |
| | the the bioreactor (4), meq/h/L | |
| V_{NO3} | Volume of the bioreactor (F), L | |

Therefore, in a further aspect, provided herein a system for water treatment, configured to perform the methods as described generally herein. All the description pertaining to the steps of manipulating of the streams and their respective parameters equally apply mutatis mutandis to a system comprising the equipment needed to carry out the steps, as known in the art.

More specifically, the system comprises a membrane contactor formed from anion exchange membrane that divides the two sides of the contactor, and a bioreactor in liquid communication with one side of the membrane contactor. The contactor extracts oxyanion contaminants a stream passing through a side contralateral to the side which is in liquid communication with the bioreactor, and the microorganisms residing in the bioreactor degrade the oxyanions passing from the contactor. The microorganisms are contained in the bioreactor and the flow rates are adjusted such that the flow of the bionutrients, of carbon source in particular, from the bioreactor into the contactor, is minimal or negligible.

Thus, the system comprises a bioreactor. The bioreactor may be of any configuration suitable to satisfy the needs of the process, namely, to reduce oxyanions provided by the contactor bio-side effluent. As described above, some suitable configurations for bioreactors and general guidelines for their exploitation may be found, inter alia, in Metcalf and Eddy, Wastewater Engineering-treatment and resource recovery, 5^{th} ed. (2014), chs 7-10. The bioreactor may be operated in fixed-bed configuration. The bioreactor may comprise a vessel holding the biomedia, and a bio-carrier, to allow the microorganisms to attach and develop functional biofilm. The porosity of the bio-carrier may be between 50 and 90% of the plan dimensions, e.g., between 75% and 85%. The surface area of the bio-carrier media is therefore rather high, e.g., between 300 and 1500 square meters per cubic meter of media, preferably between 600 and 1000 m²/m³. The bulk density of the bio-carrier media may thus be dependent on their surface-to-volume ratio, on their plan dimensions, and on the material the bio-carrier media are manufactured from. Depending on these parameters, the bio-carrier media may have the bulk density of between 90 and 250 kilograms per cubic meter, preferably between 150 and 200 kg/m³. The volume of the bioreactor may be adjusted according to the scale of the process.

The system may further comprise a polishing tank, e.g., to treat the bioreactor bleed effluent, e.g., to reduce the TOC and/or OD₆₀₀ of the effluent.

The contactor is in liquid communication with the bioreactor. The system may thus also comprise means for feeding the contaminated stream into the contactor, and means for discharging at least a portion of purified contaminated stream from an outlet of the feed side of the contactor. The system may further comprise means for recirculating the contaminated stream between an outlet of the feed side of the contactor and an inlet of the feed side of said contactor, e.g., to prolong the contact of the feed with the membrane. The recirculating may be performed, e.g., via a process feed tank. The process feed tank may therefore be in liquid communication with an inlet of the feed side of the contactor and the outlet of the feed side of said contactor.

Likewise, the system may further comprise a bio-side operating tank. The operating tank is in liquid communication with an inlet of the bio-side of the contactor and an outlet of the bioside of the contactor. The operating tank may be advantageously applied to recirculate streams through the contactor, and independently, if desired, through the bioreactor. The operating tank may therefore be in liquid communication with the bio-side of the contactor and with the bioreactor. The volumes of the operating tank are readily chosen to the needs and the scale of the process, as evident from the foregoing description.

Therefore, the system may further comprise means for feeding a decontaminating stream into the contactor on the bio-side, means for recirculating the decontaminating stream between an outlet of the bio-side of the contactor and an inlet of the bio-side of the contactor, which is preferably performed via the operating tank. The system may further comprise means for recirculating the decontaminating stream through the bioreactor.

The system may also comprise means for splitting a decontaminating stream from the outlet of the contactor, into two streams, the first which may be further fed into the bioreactor, and the second, which may be fed into the operating tank. The splitting means may be time-controllable intermittent splitters, or permanent junction-type splitters.

The contaminated water may be fed into the contactor from a source container. The container may be any suitable reservoir of a holding volume adequate to the scale of the process. Likewise, the biomedia may be held in a reservoir for biomedia, as well as the driving ion solution. These two may be contained together or separately, in either a mutual reservoir, or in two different reservoirs.

The contaminated water may be supplied into the contactor or into the process feed tank, as well as the biomedia and/or driving ions' solution, into the contactor effluent prior to entry into the bioreactor, with suitable means, e.g., pumps. The pumps, as described herein, may be of any suitable configuration, such as peristaltic pumps, piston pumps, rotary vane pumps, and other means for liquid transfer as known in the art. The biomedia and/or driving ions' solution may also be injected by a specialized injecting means, such as unidirectional liquid valves, into the bioreactor stream.

The flow rates and the pressure of the streams may be monitored by suitable means, such as pressure gauges and flow meters. Additionally, the system may comprise means for monitoring the differential pressure between the contactor sides. The suitable pressure monitoring points include but not limited to, the inlet of the contactor feed side, the inlet of the contactor bio side, the inlet and the outlet of the bioreactor, and as need be in other points wherein pressure monitoring is desired.

The system includes the bioreactor and is to a reasonable extent dependent on its efficiency. As described above, such parameters, as pH value and the ORP, are indicative of the environment of the bioreactor and the efficiency of the process. Therefore, the system may further comprise means to monitor the pH values, e.g., at the inlet and/or at least one outlet of the bioreactor. The pH may also be monitored at the inlet of the contactor. The pH and ORP may be measured using dedicated electrodes, as known in the art. The ORP electrode pay be placed in the bioreactor, or in an effluent stream of the bioreactor.

It may be desired to sample solutions during the operation of the system. Therefore, the system may comprise sampling points, optionally equipped with sampling means, such as a controllable unidirectional valve, to withdraw specimens of the liquid and/or biomass. Sampling may be particularly advantageous at the inlets and outlets of the contactor.

The parts of the system are in liquid communication with each other. This is usually achieved by the use of suitable tubing. The materials and the dimensions of the tubing may be readily adapted for the requirements of the process to be carried out, and for the scale of the system.

The preferred embodiments and the drawings demonstrating some of the embodiments of the present invention are provided to better understand the present invention, which however does not limit the invention in any respect. Many variants and equivalents may be readily envisaged by the skilled artisan; the invention therefore encompasses all of these variations and equivalents. The terms referring to system parts, e.g., denoted as “contactor”, “tank”, “bioreactor”, “pump”, and the like, comprise both a single unit of the equipment, as well as several pieces of such equipment connected consecutively or in parallel.

### EXAMPLES

### Materials and Methods

Samples were taken from IEMB setup during the monitoring of the performance. All samples were immediately filtered through sterilized 0.45 μm syringe filters and stored at 4° C. for further analysis, while samples for dissolved organic carbon (DOC) analysis were kept at −20° C. until analysis. Nitrate was measured using UV spectroscopic screening method (4500 NO₃⁻ B), while Turbidimetric Method (4500 SO₄²⁻ E) using laboratory turbidimeter (Hach, 2100 N) was adopted for the measurement of sulfate, according to APHA, Standard Methods for the Examination of Water And Wastewater, 21st ed., APHA, Washington, DC, USA, 2005. DOC was analyzed using a TOC (total organic carbon) analyzer (analytic Jena multi N/C 2100 S, Jena, Germany). Inline ORP measurement was conducted with a Pt combined electrode.

The biomass was sampled in some of the examples below. DNA extraction from 10 mL liquid from the bioreactor and bio-bead as described below (2 nos.) samples was performed using DNeasy PowerSoil Pro Kit (QIAGEN®, Carlsbad, CA, USA) according to the manufacture instructions with intermittent vortexing. Extracted DNA was quantified using Nanodrop Spectrophotometer ND-1000 (Wilmington, DE, USA) at 260 nm, yielding 260/280 ratio of 1.8±0.05 for different samples. DNA samples were stored at −20° C. Amplification reactions were performed using polymerase chain reaction (PCR) (Bio-Rad thermal cycler T100) and quantitative PCR (qPCR) with an initial denaturation step at 95° C., followed by 35 cycles of 95° C. for 30 s; 60° C. for 30 s; and 72° C. for 30 s, were used to determine the presence and number of genes in the samples. The reaction mixture consisted of 10 μL of Bio-Lab ready mix, 0.8 μL each of forward and reverse gene specific primers (stock concentration 10 μM), 7.4 μL of ultrapure DNase/RNase free water (7.4) and 1 μL of template DNA. PCR products for the nirs, nirK, dsr1, dsrA and 16S rRNA genes were run in agarose gel (1.7%) containing ethidium bromide. DNA bands were visualized and imaged using Azure 200 (Azure Biosystems, USA). All efficiency values of qPCR were between 90 and 110%. All samples and standards were run in duplicates. Calibration curves for nirS, nirK, dsr1, dsrA and 16S rRNA were prepared by performing a serial dilution copies) of plasmids. Positive controls for nirS, nirK, dsr1, dsrA and 16S rRNA were prepared by cloning the amplicons into pJET1.2 plasmid (Thermo Fisher Scientific) and confirming identity by sanger sequencing. The DNA BLAST performed between the amplicons and reference genome (Accession numbers: EF052878.1 for dsrA and AM 493693.1 for dsr1) yielded >96% homology.

### Example 1, Comparative—the Effect of the Biofilm Development in Nitrate Removal Process—Feed and Bleed Feeding Mode

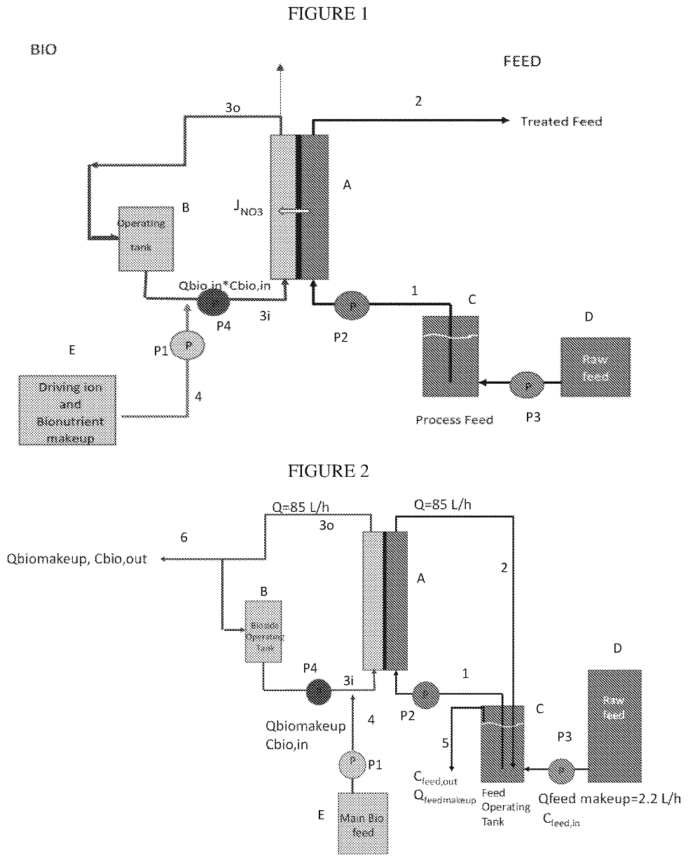

Spiral wound Donnan dialysis contactor equipped with PCA-100 membrane with 1 m long flow path was used. Both bio-side and feed side were configured in feed and bleed recycling. The system is described schematically in FIG. 2.

In the figure, nitrate was introduced by a pump P3 from raw feed container, denoted “Raw Feed”, at a flow rate of 2.2 L/h, denoted as “Qbleed makeup=2.2 L/h, Cfeed, in”, into the feed operating tank C, denoted as “Feed Operating Tank”, and this excess flow was bled from the tank by overflow stream 5, denoted as “Cfeed, out, Qfeedmakeup”. In such an arrangement the tank concentration was close to the exit concentration of the contactor. Stream 1 was fed from the feed operating tank C via pump P2, at a rate of 85 L/h, denoted as “Q=85 L/h” into the feed side of the IEMB A, and recirculated via the stream 2. The biocide operating tank B, denoted as “Biocide Operating Tank”, contained biomakeup, recirculated via pump P4, at a rate of 85 L/h, denoted as “Q=85 L/h” into the bio side of the IEMB A, as stream 3i, and therefrom as stream 30. The biobleed stream 6, denoted as “Qbiomakeup, Cbio, out” was collected in a bio-bleed tank (not shown). The driving ions and bionutrients were fed into the stream 3i by stream 4, from biofeed tank E, denoted as “Main Bio feed”, via pump P1.

The module had a flow channel width of 25 cm and a channel height of 2 mm on the feed side of the membrane and 3.5 mm on the bio-side of the membrane. The bio-side and the feed side have been recirculating to their respective operation tanks for the duration of the experiment, at a volumetric flow rate of 85 L/h. Bionutrients, carbon source (glycerol) and sodium chloride (driving ion) were fed at the inlet to the spiral wound contactor on the bio-side (receiving side) at volumetric flow rate of 0.65-1.3 L/h. Excess of bio-side stream was withdrawn at similar flow rate (Qbiomakeup, Cbio-out). The feed operating reactor was fed with solution of 3-5 mEq/L of sodium nitrate and 5 mEq/L of chloride at a volumetric flow rate of 2.2 L/h. Excess of feed stream was withdrawn at similar flow rate (Qfeedmakeup, Cfeed, out).

The contactor on the bio-side was fed with biomedia containing 100 mEq/L of sodium chloride as driving ions, glycerol, buffers, and the trace elements solution as follows: cupric sulfate-0.1 g/L, ammonium heptamolybdate-0.6 g/L, manganese sulfate-0.5 g/L, ferrous sulfate-1 g/L, calcium chloride-2 g/L, and hydrochloric acid-3.65 g/L. The further composition of the solutions and the effluents is provided in the table 2 below.

TABLE 2
Composition of process streams in example 1 (refer to FIG. 2).

| | Cfeed, in | Cfeed, out | Cbio, in | Cbio, out | Biomakeup |
|---|---|---|---|---|---|
| NO₃⁻, mEq/L | 3-5 | 0.02-0.2 | 0.035-0.065 | 0.08-0.13 | 0 |
| Cl⁻, mEq/L | 5 | 5.2 | 100 | 99.9 | 100 |
| K₂PO₄, g/L | | | | | 2.97 |
| K₂HPO₄, g/L | | | | | 0.394 |
| KH₂PO₄, g/L | | | | | 0.5 |
| NH₄Cl, g/L | | | | | 5.86 |
| MgSO₄ (50 g/L) | | | | | 4 ml |
| Glycerol, g/L | | | | | 0.21-0.26 |
| Trace elements | | | | | 5 ml |

The loading of the feed-side with nitrate is given by the equation: Nitrate Loading=Qfeed in*Cfeed in, giving 6.6-11 mEq/h. The nitrate ions moved across the membrane to the bio-side under Donnan dialysis driven by the concentration difference of the chloride. The transmembrane nitrate transfer rate is given by the equation Transmembrane nitrate flow rate=Qfeed in*(Cfeed in−Cfeed,out), giving 5.5-10.6 mEq/h

Biofilm on the bio-side of the membrane reduced the nitrate to nitrogen. This can be seen by the fact that exit concentration of nitrate on the bio-side (Cbio, out) is only 0.08-0.13 meq/L. Mass balance shows that if no nitrate reduction occurred then at a biomakeup rate (=bio-side bleed rate) of 0.65 L/h, the nitrate concentration on the bio-side would have been 8.5-16 mEq/L.

The bio-side of the contactor was cleaned with rapid flush every 6 hours. As biofilm developed on the bio-side to reduce the nitrate that transferred, the pressure-drop on the bio-side increased until the pressure drop was almost 350 mbar and the differential pressure across the membrane reach 176 mbar-near the maximum of 200 mbar allowed by the spiral wound module manufacturer. This required the system to be stopped and cleaned manually after only 3 days.

### Example 2—Contactor and Bioreactor System

The spiral wound contactor and bioreactor were set up as shown in FIG. 3. The spiral wound contactor had 2.75 m² of area, a 6 m long path length and an arrangement for co-current flow of the feed side containing nitrate, and the receiving side (bio-side) containing 50-100 mEq/L of sodium chloride as the driving ion. The feed side channel height was 1.3 mm and the bio-side channel height was 3.9 mm and the channel width was 45 cm on each side of the contactor.

The bioreactor was a column of ca. 35 L of volume, with 15 cm diameter and 2 m high. It was filled with 15-17 L of beads on which the biofilm attached. The bioreactor was inoculated with active sludge from an aquaculture system, and primed (acclimated) by operating separately by itself (detached from the contactor loops) for at least a week with a biomedia composition like that described in tables 2a and 2b. During its acclimation as a standalone bioreactor, the biomedia was augmented with increasing concentrations of nitrate beginning with 1000 mg/L of nitrate and increasing to 2500 mg/L nitrate. Glycerol was added to the biomedia in an amount that provided the 100% of the stoichiometric c requirement (5/14 mmol glycerol per mEq of nitrate) to reduce the nitrate. The biomedia was fed to the bioreactor recycle loop just upstream of the bioreactor entrance at a rate of 3 L/h. Therefore, the nitrate loading was gradually increased from 3000 to 7500 mg/h. Normalizing this by the free reactor volume (ca. 20 L excluding bead volume) gives the volume specific loading rate (NLR). The process fluid was recycled through the reactor at 23-32 L/h. The results of acclimating the reactor can be seen in FIG. 4.

It can be seen that the nitrate removal efficiency was as high a >95% at lower NLR (3 kg NO₃⁻/m³/day) and dropped to 77-90% at the highest NLR (7-7.5 kg NO₃⁻/m³/day), which is equal to a biodegradation rate that increases from 2050 to 7100 mg NO₃⁻/h.

TABLE 2
Operating conditions and performance of IEMB as described in example
2. The symbols are defined in table 1 and refer to FIG. 3.

| | |
|---|---|
| Qfeed, L/h | 60 |
| Qbio, L/h | 100 |
| Qrec, L/h | 32 |
| Qbleed, L/h | 3 |
| Cfeed, in, mEq/ L | 1.8 |
| Cfeed, out, mEq/L | 0.3 |
| Cbio, in, mEq/L | 2.6 |
| Cbio, out, mEq/L | 3.6 |
| Cr, out, mEq/L | 0.5 |
| Crec, mEq/L | 3.6 |
| J_{NO3}, mEq/h/m² | 33.8 |
| A, m² | 2.75 |
| −r_{NO3}, mEq/h/L | 4.32 |
| V_{NO3}, L | 20 |

After acclimation the fixed bed bioreactor was fed on a side-loop of the receiving side solution recirculating on the bio-side of the spiral contactor, as shown in FIG. 3. The flow rates and inlet and effluent compositions on both feed side and bio-side of the contactor are provided in table 2.

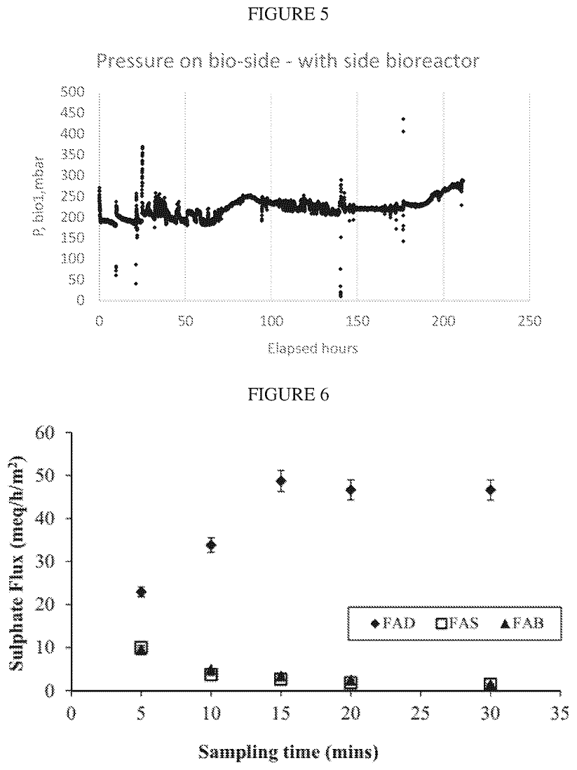

The pressure at the entrance to the bio-side of the spiral contactor was monitored with a pressure transmitter and the pressure recorded on a field logger. The experiment was run for 10 days (3 times longer that the examples 1). The result of the pressure at the entrance to the bio-side (Pbiol) as a function of time is plotted in FIG. 5.

One can see that the pressure is reasonably stable for 180 hours and only increases from 220 to 280 mbar int the last 30 hours of operation. This is to contrast with increasing from 150 to 250 mbar in example 2 where biofilm was allowed to form on the membrane contactor on the bio-side.

It is noteworthy that the bioreactor flow path is 6 times longer than the spiral contactor in examples 1 but the increase in pressure on the bio-side is only half the increase of examples 1 and it takes three times longer to occur. This is even more remarkable because the total nitrate transport in example 3 reaches 5700 mg/h, whereas it is significantly higher than in example 1.

### Example 4—Long-Term Performance with Spiral FAD-PET 75 Membrane Contactor

A spiral membrane module was procured from Spiraltec GmBH Germany equipped with FAD-PET 75 anion exchange membrane (FumaTech, GmBH) was used for Donnan contactor. The membrane divided the module into two sides—a feed side and a bio-side (receiving solution)—each connected to the outside by an inlet and outlet ports (a total of four ports). The module had a path length of 6 m for the feed and bio-media, membrane area of 2.75 m², a 0.72-mm spacer on feed side, and 5.2-mm spacer on bio-side. The membrane module was operated in co-current mode for the feed and bio-side flows.

A PVC column holding a volume of 26 L, tightly packed with 14 L perforated plastic beads (surface area=860 m²/m³, bulk density=175 kg/m³ (Aridal Bioballs, Israel), was used as fixed bed bioreactor (FBBR). The beads were pre-acclimatized with biomass collected from a reactor used to treat aquaculture (as generally described in U. Yogev, et al Aquaculture, 467 (2017) 118-126, https://doi.org/10.1016/-j.aquaculture. 2016.04.029), and further maintained in the FBBR for the development of anoxic conditions. The seeded beads were further acclimatized by feeding it 3 L/h of bio-media containing 500 mg/L nitrate along with stoichiometric carbon source (5% glycerol) over a period until it could efficiently take up the nitrate loading of 6000 mg/h to 8000 mg/h (expected nitrate flux during Donnan dialysis). The acclimatized FBBR was connected to a side loop of the return line of the receiving solution leaving from Bio-out connection of the spiral membrane module to form an ion exchange membrane bioreactor (IEMB).

The setup of the entire system is as shown in FIG. 3, where parameters like nitrate and chloride concentration along with the flow rates were varied at different stage of the IEMB operation. Tap water with nitrate at appropriate concentration was introduced to the feed side (stream 1) while chloride containing biomedia was fed to the receiving solution side (stream 3i).

The feed side containing 2.42 mEq/L nitrate was fed at 40 L/h and the bio-side with 100 mEq/L chloride was fed at 100 L/h in a co-current mode. Nitrate and chloride exchanged across the membrane by Donnan dialysis. The treated feed solution left the spiral to the drain by the Feed-Out outlet (stream 2). The receiving solution enriched with nitrate returned to the operating tank while a side loop of 20-30 L/h was routed through the FBBR to degrade the nitrate before returning to the operating tank. Operation of FBBR was in feed and bleed mode with 3 L/h bleed equal to the rate of replenishment of the biomedia. The fresh biomedia contained 100 meq/L of NaCl and glycerol as a carbon source fed at a concentration to give a stoichiometric ratio with respect to nitrate (5/14 mol glycerol to 1 mol nitrate) in FBBR. The performance of IEMB was monitored over a period of one month by changing operational parameters.

The contactor setup was operated at room temperature (25±5° C.), while temperature of FBBR was maintained at 28±2. C. Stainless steel rotary vane pumps (Fluid-O-Tech, Model No: MG209XD1PT00000) were used at feed, bio-side and recirculation line, while peristaltic pumps (Masterflex I/P series, Model No: 77200 60) were used at bio-media tanks and glycerol dosing line. Digital flow meters (Tecfluid, Model No: E-08960) were used at feed and bio-side to indicate the flow. A thermocouple was connected at inlet to the FBBR to represent the temperature of the water stream going to the bioreactor. Oxidation reduction potential (ORP) electrode was installed at the effluent/recirculation line from the FBBR to measure the inline ORP values at controlled conditions as an indicator of the prevalence of anoxic environment in the FBBR. All the sensor and flow meter transmitter were connected to a data logger (Novus Fieldlogger, Brazil) with remote transmission via internet connection to record and transmit of the various operating parameters such as flow rates (L/h), temperature (° C.), pH, and ORP (mV). Composition parameters of the different streams such as nitrate, dissolved organic carbon (DOC), sulfate and ORP were measured from samples taken during the course of each experimental run.

The nitrate transport across the membrane was calculated by subtracting the outlet feed side loading from the inlet feed side nitrate loading.

The IEMB set up was run over a month and operational performance of the whole setup was monitored. The representative data of nitrate transport from feed to bio-side during steady state of FBBR was between 70 and 80 mEq/h (about 75±3 mEq/h) for 3 L/h of bio-makeup flow (stream 4) and between 55 and 60 mEq/h for 1.5 L/h of bio-makeup flow, which could be attributed to the reduction of driving ions concentration (added to stream 4).

Significant biodegradation of nitrate was observed with average effluent nitrate concentration of 35±5 mg/L during first two weeks after reaching the steady state with residual DOC of 6±1 mg/L. The ORP was well within the anoxic range (−110 mV to −310 mV), satisfying the denitrification scenario. FBBR produced the highest nitrate biodegradation of 104 mEq/h at corresponding ORP value of −310 mV. Extending the experiment, lead however, to reduction in denitrification, as demonstrated in Example 5 below, due to extreme anaerobic conditions developing in the bioreactor, attributable to sulfate-reducers overgrowth which generate sulfide that inhibits nitrate-reducing microbiota.

### Example 5—Effect of Sulfate Accumulation and Bioreactor Maintenance

The technological scheme as described in the Example 4 was run over three weeks. Starting from day 12, the denitrification rate reduced significantly to 50 mEq/h. This was accompanied by the development of strong hydrogen sulfide odor from the bioreactor, steady reduction of the pH to below 6.3, and ORP reaching below −350 to −450 mV.

The feed stream (stream 1) contained about 22±4 mg/L of sulfate, and thus during the operation of IEMB, about 640 mg/h-1040 mg/h sulfate crossed the membrane from the feed side to the bio-side d made its way to the FBBR. Consequently, the steady accumulation of bio-side sulfate was strongly correlated to the upset of the reactor in terms of denitrification.

Subsequently, remedial actions were taken for recovering the FBBR activity. Such actions included, draining of the FBBR, H₂O₂ (1200 mg/L) rinsing of the tubing connected in IEMB while isolating FBBR on the side, and restarting the FBBR with increased nitrate loading. In this process, denitrifiers were stimulated leading to the inhibition of sulfate reduction due to competition, symbiosis, and antagonism between sulfate reducers and denitrifiers.

Further three runs were performed at a fixed sulfate concentration of 250 mg/L while varying nitrate concentration from 300, 150 and 50 mg/L with a corresponding nitrate to sulfate ratios of 1.2, 0.6 and 0.2. A control was also run in each set containing only nitrate along with the bio-media. For these runs, pre-acclimatized plastic beads from the polish tank connected with the IEMB were used, to shorten the equilibration time, in a 1 L anaerobic reactor. Experiments were performed at stoichiometric C/N ratio using glycerol (5% v/v) as the carbon source. Operational parameters such as residual nitrate, residual sulfate and ORP were measured daily until the attainment of a stage which provided no further reduction of nitrate (at least two consecutive residual nitrate concentration values were similar).

Nitrate reduction was observed to be increasing with increase in nitrate to sulfate ratio, yielding a maximum 92% reduction at a ratio of 1.2:1. However, no sulfate reduction was observed at the nitrate to sulfate ratios of 1.2, and 0.6, while at a ratio of 0.2 produced approximately 45% of sulfate reduction with no nitrate reduction.

The biomass was then sampled after the 1.2 and 0.6 runs. The results indicated that genes' copy number of nirs and nirK depends only on nitrate concentrations with no differences between the control and the sulfate amended cultures. Moreover, the absence of sulfate reduction in the high nitrate to sulfate ratios is not corresponding with the elimination of sulfate-reducing bacteria from the beads and the liquid, as genes coding for sulfate reduction were also present in the cultures, illustrating the potential for sulfate reduction. Consequently, it may be assumed that there is the equilibrium and coexistence of the two communities, but their activity, denitrification, or sulfate reduction is dependent on the operating conditions, specifically nitrate to sulfate ratios.

Since the sulfate accumulation occurs due to sulfate exchange in the contactor, it was hypothesized that ion-exchange membranes that is less permeable to sulfate may exist. To this end, batch screening experiments of Donnan dialysis were carried out with three different anionic membranes, namely FAD, FAS, and FAB by Fumatech GmbH with ion exchange capacity of 1.5 meq/g, 1.0 meq/g and 1.0 meq/g, and designated by the company for Donnan dialysis, electrodialysis, and electrodialysis with bipolar membrane, respectively. Membranes were characterized via sulfate transport by Donnan dialysis from feed (0.005 M NaCl+100 mg/L SO4-2) to receiver (0.05 M NaCl) compartment. The results are presented in FIG. 6. In the FIG. 6, sulfate flux, expressed in mEq/h/m², is plotted along the vertical axis (denoted “Sulphate Flux (meq/h/m²)”), versus time, plotted along horizontal axis in minutes (denoted “Sampling time (mins)”). As can be seen from FIG. 6, FAD membrane produced a significant sulfate flux which linearly increased up to 15 min and then became constant. On the other hand, FAB and FAS membranes were observed to produce comparatively similar but significantly lesser sulfate flux.

### Example 6—Long-Term Performance with Spiral FAS-PET 75 Membrane Contactor

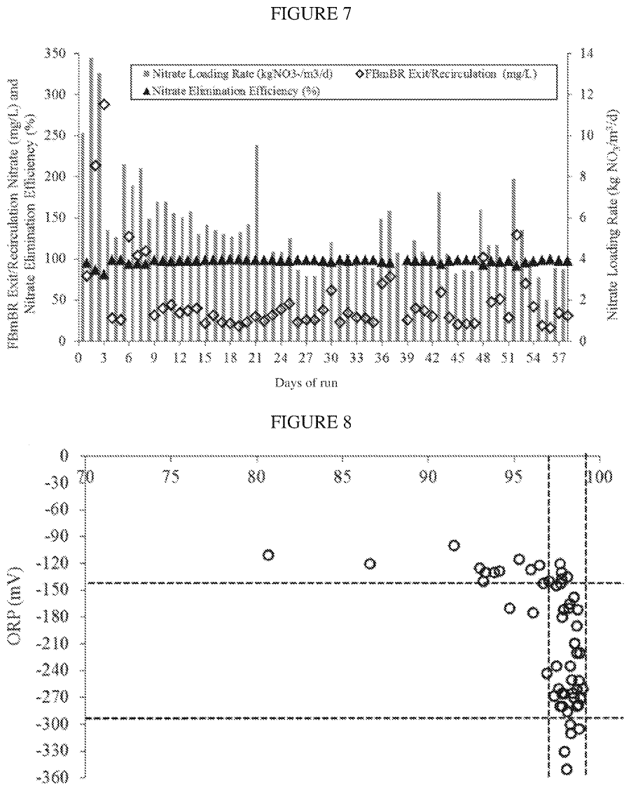

Spiral wound contactor equipped with anion exchange membrane (FAS-PET 75, Spiraltec GmBH) with a revised channel heights produced using combinations of 1.3 mm net spacers (1×1.3 mm on feed side and 3×1.3 mm on the bio-side) was adopted. The path length (6 m), and membrane area (2.75 m²) were unchanged from the described in the example 4. The larger feed channel height was chosen to accommodate additional nitrate loading while maintaining the differential pressure below a critical limit. Initially, the membrane module FAS-PET 75 integrated with FBBR was operated with a feed side nitrate concentration of 110±10 mg/L and feed flow rate of 60 L/h. In this system the flow from bio-side was 100 L/h containing 50 meq/L of chloride. Stoichiometric glycerol (5% v/v) with respect to nitrate was fed as a carbon source for denitrification. The IEMB system was operated in feed and bleed mode with bio-side bleed of 3 L/h and the operational performance for a period of around eight weeks was depicted in FIG. 7. In the FIG. 7, recirculating nitrate concentrations and nitrate elimination efficiency are plotted on the left vertical axis, versus time elapsed, in days, plotted on the horizontal axis, with nitrate loading rate given on the right vertical axis. Recirculating nitrate concentrations, given in mg/L, are presented by empty diamonds (⋄) on the chart, and denoted as “FBmBR Exit/Recirculation (mg/L)” in the legend and the left vertical axis title, nitrate elimination efficiency, given in percentage, are presented by filled triangles (▴) on the chart, and denoted as “Nitrate Elimination Efficiency (%)” in the legend and the left vertical axis title, and nitrate loading rate, given in kilograms of nitrate per cubic meter per day, are presented by filled bars on the chart and filled squares (▪) in the legend, and denoted as “Nitrate Loading Rate (kgNO3−/m³/d))” in the legend and the right vertical axis title.

It can be seen that the IEMB removed 70-80% of the nitrate from the feed stream, and the calculated nitrate elimination efficiency of the FBBR-IEMB system (100−% release of feed nitrate through the bio-side bleed) was found in the range of 98-99%. IEMB treated a very high nitrate loading of close to 6.5 kg NO₃⁻/m³/d during initial phase of steady state, while average nitrate loading rate was approximately 5.0 kg NO₃⁻/m³/d. It can also be seen that the system produced steady state performance of nitrate elimination even at dynamic nitrate loading conditions. During the operation, the increase in nitrate concentration in the feed outlet was observed implying a temporary reduction in the transmembrane nitrate flux. The reduction was due to the fouling of membrane module leading to a lower nitrate mass transfer coefficient. However, nitrate exit in the feed outlet (30±5 mg/L) and bio-side bleed (30±10 mg/L) were still well below the statutory limits of different jurisdictions. Tap water flushing has readily reduced the pressure drop at the bio-side and served as one of the indicators for effective membrane rinsing and recovery of the flux.

ORP values were recorded daily during the operation of IEMB system and correlated to the nitrate biodegradation efficiency, as seen in the FIG. 8. In the FIG. 8, oxidation-reduction potential, in millivolts, denoted as “ORP (mV)”, is plotted on the vertical axis, versus nitrate elimination efficiency, in percentage, plotted on the top horizontal axis. The dashed lines delineate the working range associated with the optimal efficacy. It can be seen from FIG. 8 that a wide range of ORP values (−110 mV to −280 mV) were associated with a relatively narrow range of nitrate biodegradation efficiencies (>93%). Except for two points, all degradation efficiencies <96% had ORP values more negative than −140 mV.

During the operation of IEMB, excess biomass growth inside the FBBR was also observed, which deteriorates the quality of treated effluent from the bioreactor. Periodic manual water flushing (once in two months) worked well for the effective removal of such biomass. Generally, the OD₆₀₀ values of the bioreactor effluent rose gradually, and values of between 0.3 and 0.5 were correlative with the need for flushing of the bioreactor.

This example demonstrates that implementing the technological assembly as described herein it is possible to achieve very efficient oxyanion removal to purify water to the levels acceptable for environmental use. The assembly requires minimal routine maintenance to remain operational and is not prone to any observable deterioration for long time intervals, unlike the existing technological solutions for combined ion-exchange membrane bioreactors.

### Example 7—Effect of Ratio of Carbon Source to Nitrate (Expressed as % of Stoichiometric Ratio) on Oxyanion Removal Efficiency

The technical assembly as described in Example 6 was used herein. To investigate the effect of glycerol dosing on denitrification efficiency, glycerol dosing in the pre-acclimatized FBBR was varied from 0% to 125% (0, 50, 75, 100, and 125) of stoichiometric requirement of the given nitrate loading in a sequential manner. The change of glycerol dosing was made only after achieving the steady state of denitrification for the given condition. ORP was also measured at these different stoichiometric proportions of glycerol.

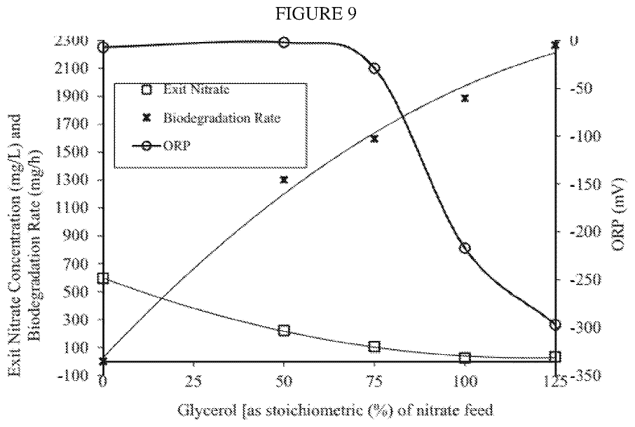

The summarized results of the study are presented in FIG. 9 as nitrate biodegradation rate, effluent nitrate concentration and ORP vs. percentage stoichiometric glycerol dosing. In the FIG. 9, nitrate biodegradation rate, expressed in milligrams per hour, and effluent nitrate concentration, expressed in milligrams per liter, are plotted on the left vertical axis, versus percentage stoichiometric glycerol dosing, plotted on the horizontal axis, with ORP given on the right vertical axis, expressed in millivolts. Nitrate biodegradation rate, given in mg/h, are presented by cross symbol (x) on the chart, and denoted as “Biodegradation Rate” in the legend and “Biodegradation Rate (mg/h)” on the left vertical axis title, effluent nitrate concentration, given in mg/L, are presented by empty squares (□) on the chart, and denoted as “Exit Nitrate” in the legend and “Exit Nitrate Concentration (mg/L)” on the left vertical axis title, and ORP values, given in mV, are presented by empty circles (o) on the chart, and denoted as “ORP” in the legend and “ORP (mV)” on the right vertical axis title. Glycerol amounts are plotted along the horizontal axis, denoted as “Glycerol [as stroichiometric (%) of nitrate feed” on the axis title.

It can be observed from FIG. 9 that rate of nitrate biodegradation increased with increased glycerol dosing (expressed as % of stoichiometric level) while ORP consistently decreased. The highest nitrate biodegradation rate of 2268 mg/h with ORP of −297 mV was found at 125% stoichiometric glycerol dosing, and slightly lower yet comparable rate 1900 mg/h with 100%. Excess amount of glycerol resulted in the extremely negative ORP of −297 mV due to the transition of anoxic to anaerobic conditions inside FBBR.

1. A method of decontaminating water of oxyanions, said method comprising:
passing a contaminated water stream through a feed side of a contactor, said contactor comprising said feed side and a bio-side separated by an anion-exchange membrane,
passing a decontaminating stream on said bio-side, said decontaminating stream comprising driving ions in a concentration sufficient to drive said oxyanion through said anion-exchange membrane from said feed side to said bio-side, to form oxyanion-rich decontaminating stream,
passing at least a portion of said oxyanion-rich decontaminating stream through a bioreactor, wherein said bioreactor comprises microorganisms capable of metabolizing said oxyanion, and bionutrients comprising a carbon source, to form a bioreactor effluent, wherein said bioreactor effluent is substantially decontaminated from said oxyanion, and
recirculating said bioreactor effluent through said bio-side of said contactor,
wherein said bioreactor effluent and said decontaminating stream on said bio-side of said contactor are essentially free of said carbon source.

2. The method according to claim 1, wherein said contactor is a spiral membrane contactor.

3. The method according to claim 1, wherein said contactor has a channel height of between 0.5 mm to 2.5 mm on the feed side, and between 2.5 mm and 10.0 mm on the bio-side.

4. The method according to claim 1, wherein said passing of a contaminated water stream and said passing of said decontaminating stream are carried out in a co-current contacting pattern in said contactor.

5. The method according to claim 1, wherein said oxyanion is selected from the group consisting of nitrate, nitrite, perchlorate, chromate, arsenite, arsenate, bromate, selenate, and chlorate.

6. The method according to claim 1, wherein said anion-exchange membrane conducts less than 2 milliequivalents of sulfate anions per square meter per hour from 100 mg/L solution, versus a 50 milliequivalent solution of sodium chloride as driving ions.

7. The method according to claim 1, wherein said oxyanion is nitrate.

8. The method according to claim 1, wherein said method further comprises recirculating at least a portion of said oxyanion-rich decontaminating stream via an operating tank, said operating tank being in liquid communication with said bio-side of said contactor.

9. The method according to claim 8, wherein said recirculating comprises transferring a stream from said operating tank into said bio-side of said contactor.

10. The method according to claim 8, wherein said passing at least a portion of said oxyanion-rich decontaminating stream through a bioreactor and said recirculating said bioreactor effluent through said bio-side of said contactor, are carried out via said operating tank.

11. The method according to claim 1, wherein said method further comprises periodically or continuously monitoring at one or more points the process parameters comprising pH values, temperature, flow rates, optical density at wavelength 600 nm (OD₆₀₀), oxidation-reduction potential (ORP), and inlet pressures on the feed side and bio-side of said contactor.

12. The method according to claim 1, wherein said method further comprises combining said at least a portion of said oxyanion-rich decontaminating stream passing into said bioreactor, with a bio-makeup stream comprising said carbon source.

13. The method according to claim 12, wherein said bio-makeup stream further comprises buffering agents and salts comprising ammonium and trace elements, said trace elements comprising magnesium, calcium, manganese, molybdenum, and copper.

14. The method according to claim 12, wherein said bio-makeup stream has a pH sufficient to maintain the pH of said bioreactor effluent at between 6.4 and 8.0.

15. The method according to claim 12, wherein if an ORP value measured in said bioreactor effluent is more negative than −300 mV, said method further comprising combining said bio-makeup with an additional amount of said oxyanion, in said bio-makeup stream.

16. The method according to claim 1, wherein said method comprises maintaining a temperature of said bioreactor between 20 and 30 degrees Celsius.

17. The method according to claim 12, wherein said method further comprises extracting periodically or continuously a portion of said bioreactor effluent as a bio-bleed stream, wherein a volume said portion being between 50% and 100% of the volume of said bio-makeup stream.

18. The method according to claim 1, wherein said bioreactor comprises porous bio-carrier media for carrying said microorganisms, wherein a surface area of said bio-carrier media is between 600 and 1000 square meters per cubic meter of media.

19. The method according to claim 18, wherein a dry weight of biomass comprising said microorganisms on said bio-carrier media is between 3 and 6 grams per square meter.

20. The method according to claim 17, wherein said method further comprises periodically flushing said bio-side of said contactor and/or said bioreactor, and wherein said periodically flushing has the periodicity of between once a week to once in three weeks for said contactor, and between once a month to in three months for said bioreactor.

21. The method according to claim 20, wherein said flushing of said bioreactor is conducted when said OD₆₀₀ measured in said bioreactor effluent is between 0.3 to 0.5.

22. The method according to claim 1, wherein said driving ions are chloride ions or bicarbonate ions.

23. The method according to claim 1, wherein said concentration sufficient to drive said oxyanion through said anion-exchange membrane is between 40 and 10 mmol of said driving anion per 1 mmol of said oxyanion.

24. The method according to claim 20, wherein said oxyanion is nitrate, said contaminated water stream comprises between 50 and 300 mg per liter of nitrate, wherein said driving ions are chloride, said decontaminating stream comprises 50 to 200 milliequivalents of chloride, wherein said recirculating at least a portion of said oxyanion-rich decontaminating stream is performed via an operating tank, wherein said contactor is a spiral membrane contactor, wherein said bio-makeup stream contains sufficient amount of said carbon source and said oxyanion, and a pH value, to maintain the ORP value between −140 m V and −290 mV, and said pH value between 6.4 and 8.0, wherein the operational parameters of said method are selected from the group consisting of a) the flow rate of said contaminated stream is between 30 and 80 liters per hour, b) the flow rate of said decontaminating stream is between 40 and 120 liters per hour, c) the volume of said bioreactor is between 20 and 30 liters and said bioreactor being filled at between 12 and 18 liters with a biocarrier media having a surface area of between 600 and 1000 square meters per cubic meter, d) the flow rate of said at least a portion of said oxyanion-rich decontaminating stream passing through said bioreactor is between 15 and 35 liters per hour, e) the flow rates of said bio-makeup stream and said bio-bleed stream are individually and independently between 2 and 5 liters per hour, and a combination of any of these operational parameters, such that said operational parameters correspond to said contactor having a path of between 5-7 meters and membrane surface area of between 2.5 to 3 square meters, or adjusted to corresponding proportional values, and
wherein the periodically flushing of said contactor and/or said bioreactor has the periodicity of between once a week to once in three months.

25. A system for water treatment operating according to a method as described in claim 1.

26. A system for water treatment comprising:
a contactor for contacting a contaminated water stream comprising an oxyanion as said contaminant, said contactor comprising a feed side, and a bio-side, separated by an anion-exchange membrane, and
a bioreactor comprising microorganisms capable of metabolizing said oxyanion, wherein said bioreactor is in liquid communication with said bio-side of said contactor.

27. The system according to claim 26, wherein said system further comprises means for feeding said contaminated stream into said contactor on said feed side, and means for discharging at least a portion of purified contaminated stream from an outlet of said feed side of said contactor.

28. The system according to claim 27, further comprising means for recirculating said contaminated stream between an outlet of said feed side of said contactor and an inlet of said feed side of said contactor, optionally via a process feed tank, said process feed tank being in liquid communication with an inlet of said feed side of said contactor and said outlet of said feed side of said contactor.

29. The system according to claim 27, further comprising a bio-side operating tank in liquid communication with an inlet of said bio-side of said contactor and an outlet of said bio-side of said contactor.

30. The system according to claim 29, further comprising means for feeding a decontaminating stream into said contactor on said bio-side, means for recirculating said decontaminating stream between an outlet of said bio-side of said contactor and an inlet of said bio-side of said contactor.

31. The system according to claim 30, further comprising means for recirculating said decontaminating stream through said bioreactor.

32. The system according to claim 31, wherein said means for recirculating said decontaminating stream through said bioreactor are in liquid communication with said operating tank and said bioreactor.
